(19) United States
(12) Patent Application Publication
(10) Pub. No.: US 2017/0071394 A1
(43) Pub. Date: Mar. 16, 2017

(54) COFFEE DRIPPER

(71) Applicant: Shingo Numata, Hokkaido (JP)

(72) Inventor: Shingo Numata, Hokkaido (JP)

(21) Appl. No.: 15/356,378

(22) Filed: Nov. 18, 2016

Related U.S. Application Data
(63) Continuation of application No. PCT/JP2016/074246, filed on Aug. 19, 2016.

(30) Foreign Application Priority Data
Sep. 10, 2015 (JP) 2015-178489

(51) Int. Cl. A47J 31/08; A47J 31/06

(52) U.S. Cl. CPC A47J 31/08; A47J 31/0626

(57) ABSTRACT

A coffee dripper includes a first, second and a third plate materials. Each of the first, second and third plate material is a generally triangle in shape and includes a convex engaging part and a concave engaging part. The convex engaging part of the first plate material engages the concave part of the second plate material, the convex engaging part of the second plate material engages the concave engaging part of the third material, the convex engaging part of the third plate material engages the concave engaging part of the first material thereby forming the pyramidally assembled coffee dripper.

### CROSS REFERENCE TO RELATED APPLICATIONS

This application is a Continuation Application of International Application No. PCT/JP2016/074246, filed Aug. 19, 2016 which claims the benefit of Japanese Priority Patent Application JP 2015-178489 filed Sep. 10, 2015, the entire contents of these applications of which, including specifications, claims and drawings, are incorporated herein by reference.

### TECHNICAL FIELD

The present invention relates to a coffee dripper for extracting liquid such as coffee or tea.

### BACKGROUND ART

Among drippers for extracting coffee and the like, the most general one is what having a conical or an approximate fan-like tube shape which matches with a shape of a paper filter having a conical or an approximate fan-like tube shape, wherein the paper filter is set to the coffee dripper, coffee powders are put into the filter, and hot water is poured from above to extract coffee liquid. Such coffee dripper is formed by a single component using a material having rigidity such as of metal, resin, ceramics and so on.

For example, as a foldable coffee dripper convenient for carrying, there is disclosed a one consisting of a super elastic or shape-memory alloy, in which a member supporting a filter is wound concentrically.

In addition, as a coffee dripper which allows compact storage, there is disclosed a one consisting of a frame part of super elastic alloy which may define a shape of a filter part formed by a water permeable cloth, and supporting members for supporting the filter part on a receptacle.

### SUMMARY OF INVENTION

A coffee dripper includes a first, second and a third plate materials. Each of the first, second and third plate material is a generally triangle in shape and includes a convex engaging part and a concave engaging part. The convex engaging part of the first plate material engages the concave part of the second plate material, the convex engaging part of the second plate material engages the concave engaging part of the third material, the convex engaging part of the third plate material engages the concave engaging part of the first material thereby forming the pyramidally assembled coffee dripper.

Each of the first, second and third plate materials may include two convex engaging parts and two concave engaging parts, and the two convex engaging parts of one of the plate materials may engage with the two concave engaging parts of the plate material adjacent thereto.

### BRIEF DESCRIPTION OF DRAWINGS

FIG. 1 is a perspective view representing a usage pattern of a coffee dripper according to a first embodiment of the present invention.

FIG. 2 is a top plan view showing the coffee dripper in an assembled condition, according to the first embodiment of the present invention.

FIG. 3 is a perspective view showing the coffee dripper in the assembled condition.

FIG. 4 is a view showing a plate material la which forms a coffee dripper 1.

FIG. 5 is an enlarged view showing a condition where convex engaging parts 14a, 15a and concave engaging parts 16a, 17a are engaged.

FIG. 6 is a view showing a coffee dripper according to a second embodiment of the present invention.

FIG. 7 is a view showing a coffee dripper according to a third embodiment of the present invention.

### DESCRIPTION OF EMBODIMENTS

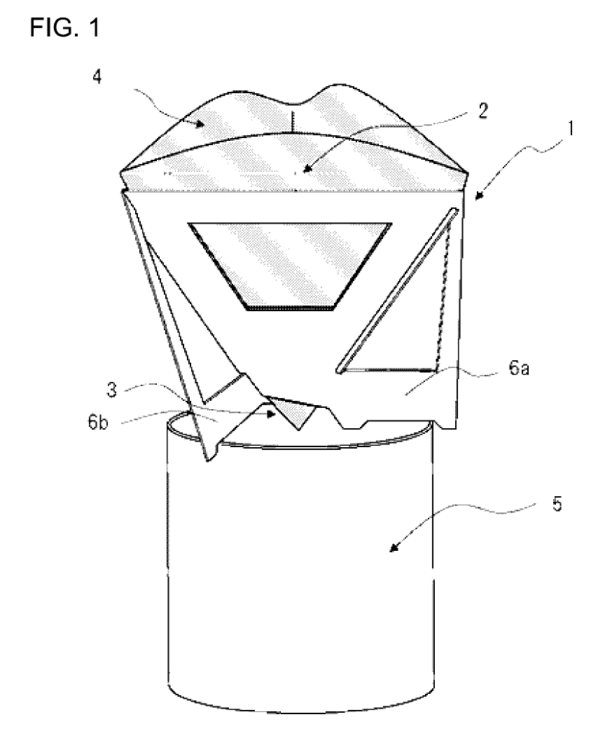

FIG. 1 is a perspective view representing a usage pattern of a coffee dripper 1 according to a first embodiment of the present invention. As shown in FIG. 1, the coffee dripper 1 is used such that the coffee dripper 1 in an assembled condition is placed on a cup 5. The coffee dripper 1 in the assembled condition has an upper opening 2 and an opening for extraction 3. A conical paper filter 4 may be inserted from the upper opening 2, and the inserted conical paper filter 4 may be held by the coffee dripper 1 in the assembled condition.

Powders, solids, etc. which are intended for extraction such as coffee powders are put in the conical paper filter 4, liquid is poured from above, extracted liquid is extracted through the opening for extraction 3, and received in the cup 5.

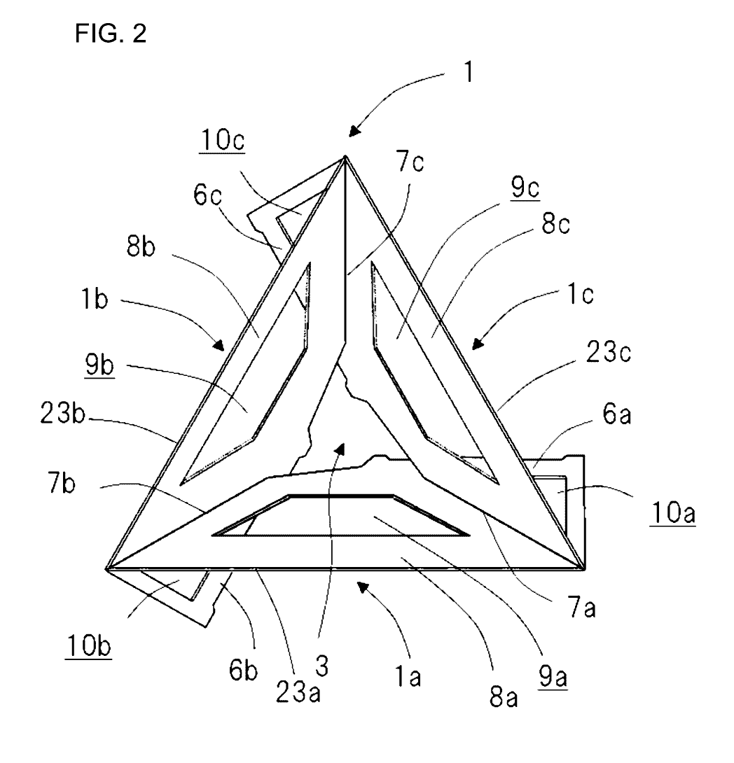

FIG. 2 is a top plan view showing the coffee dripper 1 in an assembled condition, according to the first embodiment of the present invention in an assembled condition.

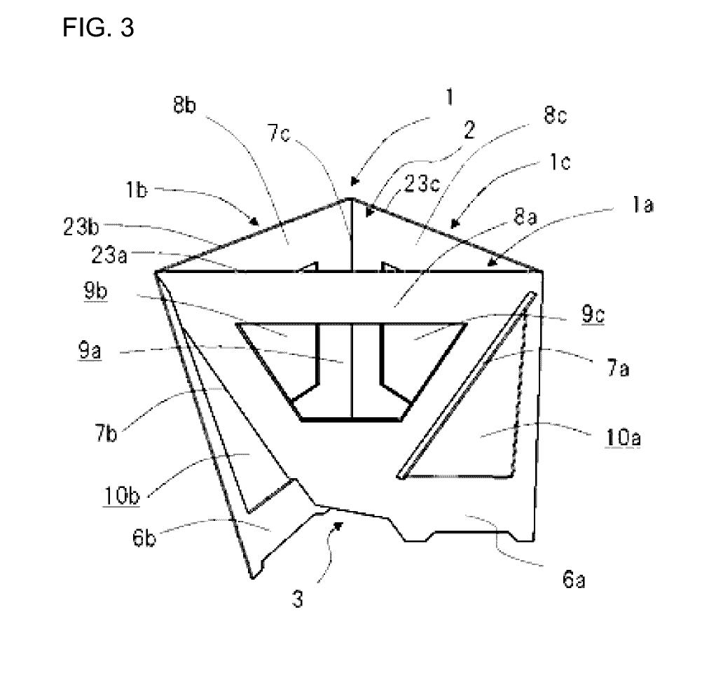

FIG. 3 is a perspective view showing the coffee dripper 1 in the assembled condition.

The coffee dripper 1 comprises three plate materials 1a, 1b and 1c having rigidity. The three plate materials 1a, 1b and 1c all have the same specification. Each of the plate materials 1a, 1b and 1c may be formed using steels such as stainless, or may be formed using non-ferrous metal such as titanium and/or titanium alloy and/or resin materials.

In the present embodiment, the plate materials 1a, 1b and 1c are removable with respect to one another. When assembling the plate materials 1a, 1b and 1c, adjacent sides thereof with respect to one another are aligned and coupled so that the plate materials may be pyramidally assembled to thereby configure the coffee dripper 1. In other words, the coffee dripper 1 is provided such that it may be disassembled.

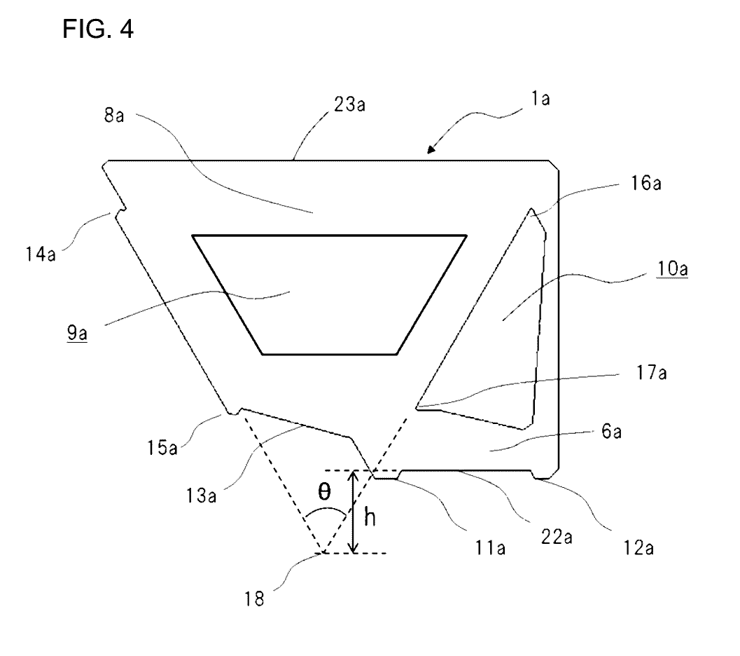

FIG. 4 is a view showing the plate material 1a which configures the coffee dripper 1.

Since the specification of each of the plate materials 1a, 1b and 1c is common, description is made only for the plate material 1a, and descriptions for plate materials 1b and 1c are omitted. The plate material 1a makes up an approximate rectangular trapezoid (trapezoid having a right angle). The plate material 1a is of a one plate material formed by a paper filter holding part 8a of approximate isosceles triangle and a placing part 6a of approximate right triangle.

The paper filter holding part 8a is formed by a principal surface of an isosceles triangle which angle of a vertex θ, provided by an intersection of equal sides of the paper filter holding part 8a with an approximate isosceles triangle shape, is about 60 degrees, for example. The paper filter holing part 8a has a linear side for configuring opening for extraction 13a consisting of a cutout. The shape of the side for configuring opening for extraction 13a of the plate material 1a may be arbitrarily determined to the extent that a engaging function is not compromised. The paper filter holding part 8a has a linear side for configuring upper opening 23a on top thereof. The paper filter holding part 8a has an opening of the holding part 9a (second opening) consisting of an isosceles trapezoid, for example, in order to urge discharge of gas generated from powders when extracted, and also to reduce weight. However, it is required that the shape of the opening for the holding part 9a is within the extent that the engaging function and a function to hold the conical paper filter 4 are not compromised.

Convex engaging parts 14a and 15a are provided on one of the isosceles sides (one of the two sides excluding the side for configuring upper opening 23a) of the paper filter holding part 8a at a center part in a direction along the isosceles side. In addition, on the other of the isosceles sides (the other of the two sides excluding the side for configuring upper opening configuration 23a) of the paper filter holding part 8a, concave engaging parts 16a and 17a are provided at a center part in the direction along the isosceles side.

The placing part 6a has an opening 10a (first opening) of a triangle shape, for example, at a center part thereof, and a part excluding the opening of the placing part forms an L shape. The opening 10a of the placing part 6a is provided for reducing weight of the plate material 1a. In the present embodiment, the opening 10a of the placing part 6a, and the upper and lower concave engaging parts 16a and 17a are provided together, but the opening 10a of the placing part 6a, and the concave engaging parts 16a and 17a may be provided with space (in other words, the opening 10a of the placing part 6a, and the concave engaging parts 16a and 17a may be provided independently). In this case, the concave engaging parts 16a and 17a may be provided in a same opening, or they may also be provided independently.

When the three plate materials 1a, 1b and 1c all having the common specification are assembled by making one of the isosceles sides of the paper filter holding part 8a aligned with the other of the isosceles sides of the paper filter holding part adjacent thereto, a triangular pyramid shape is formed which fits to the conical paper filter 4 having central angle of 180°. Further, length of the isosceles sides of the isosceles triangle which form the paper filter holding part 8a is arbitrary, and it is matched with a size of the conical paper filter.

With the three plate materials 1a, 1b and 1c assembled, by engaging the convex engaging parts 14a and 15a of each of the plate materials 1a, 1b and 1c with the concave engaging parts 16a and 17a of the other plate material 1a, 1b and 1c adjacent thereto when assembled, the three plate materials 1a, 1b and 1c are coupled. Thus, the three plate materials 1a, 1b and 1c are fixed respect to one another to make the coffee dripper 1 with high rigidity.

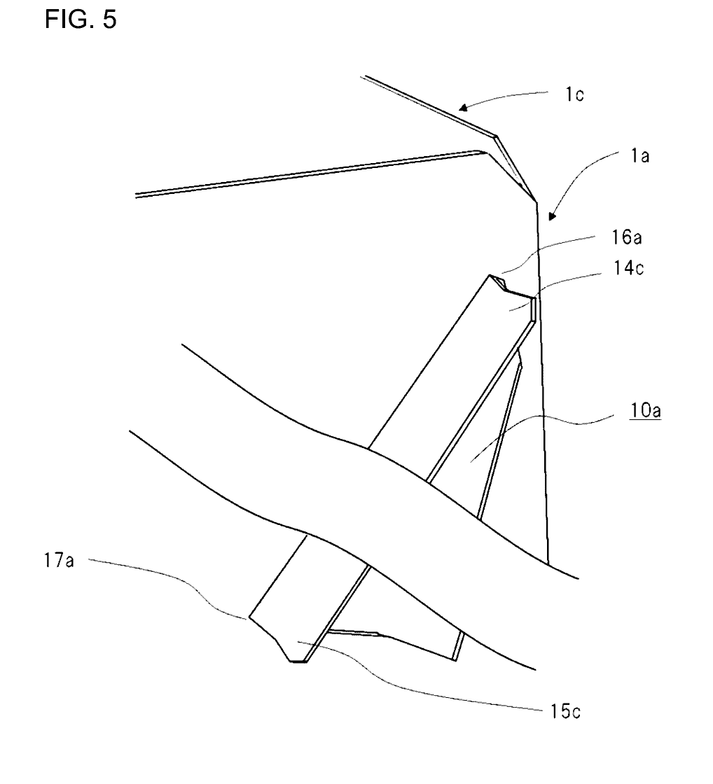

FIG. 5 is an enlarged view showing a condition where the convex engaging parts 14a, 15a and the concave engaging parts 16a, 17a are engaged.

In FIG. 5, the convex engaging parts 14c and 15c of the plate material 1c is engaged with the concave engaging parts 16a and 17a of the adjacent plate material 1a. At this point, the convex engaging parts 14c and 15c have equivalent length dimensions to that of the concave engaging parts 16a and 17a, and the plate material 1c is bended such that the convex engaging parts 14c and 15c are inserted to the concave engaging parts 16a and 17a to be engaged. In addition, the convex engaging parts 14b and 15b of the plate material 1b are engaged with the concave engaging parts 16c and 17c of the adjacent plate material 1c, and also the convex engaging parts 14a and 15a of the plate material 1a are engaged with the concave engaging parts 16b and 17b of the adjacent plate material 1b to thereby couple the three plate materials 1a, 1b and 1c, and thus, the three plate materials 1a, 1b and 1c are fixed with respect to one another. Thereby the coffee dripper 1 is assembled to have the triangular pyramid shape.

In the assembled condition, each of the sides for configuring opening for extraction 13a, 13b and 13c of each of the plate materials 1a, 1b and 1c together form the opening for extraction 3. In the assembled condition, each of the sides for configuring upper opening 23a, 23b and 23c of each of the plate materials 1a, 1b and 1c together form the upper opening 2. In the assembled condition, each of the paper filter holding parts 8a, 8b and 8c of each of the plate materials 1a, 1b and 1c together hold the conical paper filter 4. In addition, in the assembled condition, as shown in FIG. 3, the placing parts 6a, 6b and 6c are out of phase with respect to one another by 120° seen from above, and when placed, stability is provided as a result of a three-point support.

An anti-falling inner stopper 11a and anti-falling outer stopper 12a are formed at the lower end of the placing part 6a. Positions of the anti-falling inner stopper 11a and anti-falling outer stopper 12a are determined according to a diameter of an intended cup. Among each of the sides of the paper filter holding part 8a, the side opposite to the placing part 6a has convex engaging parts 14a and 15a formed, which respectively engages with the concave engaging parts 16a and 17a of the other plate materials 1a, 1b and 1c.

Distance h from a lower side of the placing part 22a to the lowermost point of the paper filter 18 which is the intersection of the equal sides of the paper filter holding part 8a, consisting of the approximate isosceles triangle (that is to say, the vertex of the approximate isosceles triangle) may be determined arbitrarily. If the distance is made shorter, a position of the conical paper filter 4 in use becomes higher with respect to the cup 5, and thus, even when an amount of liquid extraction is large, the conical paper filter 4 is less likely to get immersed to the extracted liquid. On the contrary, if the distance h is made longer, the conical paper filter 4 in use may be easily immersed to the extracted liquid, but weight of the plate material 1a may be lightened.

As described in the above, according to the present embodiment, the coffee dripper 1 may be a body having high rigidity, which has enough rigidity required in use. Thereby, it is possible to provide the coffee dripper 1 which is foldable or which can be disassembled, and also which has high rigidity

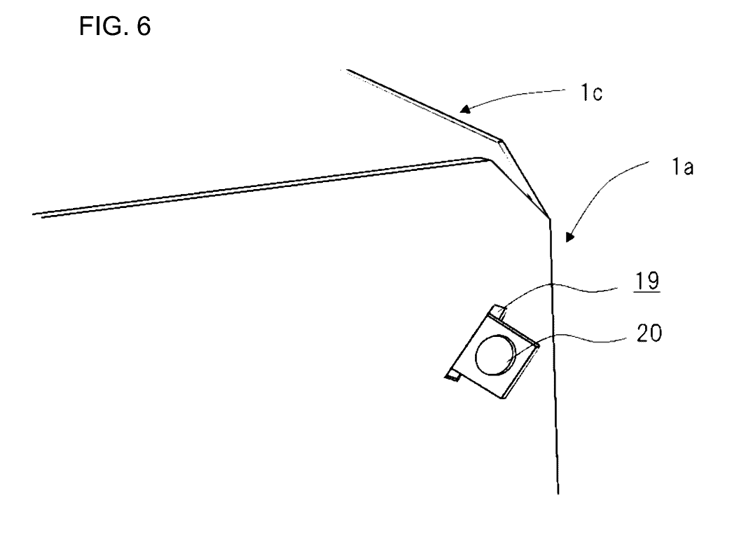

FIG. 6 is a view showing a coffee dripper according to a second embodiment of the present invention. In FIG. 6, parts corresponding to each of the parts shown in the first embodiment are shown with identical reference numerals to the cases in FIG. 1 to FIG. 5, and descriptions are omitted. A difference between the coffee dripper according to the embodiment of FIG. 6 and the coffee dripper 1 according to FIG. 1 to FIG. 5 is that the openings of the placing part 10a, 10b and 10c are eliminated. In this case, a slit 19 is provided as a concave engaging part, and a fitting 20 is provided as a engaging projection.

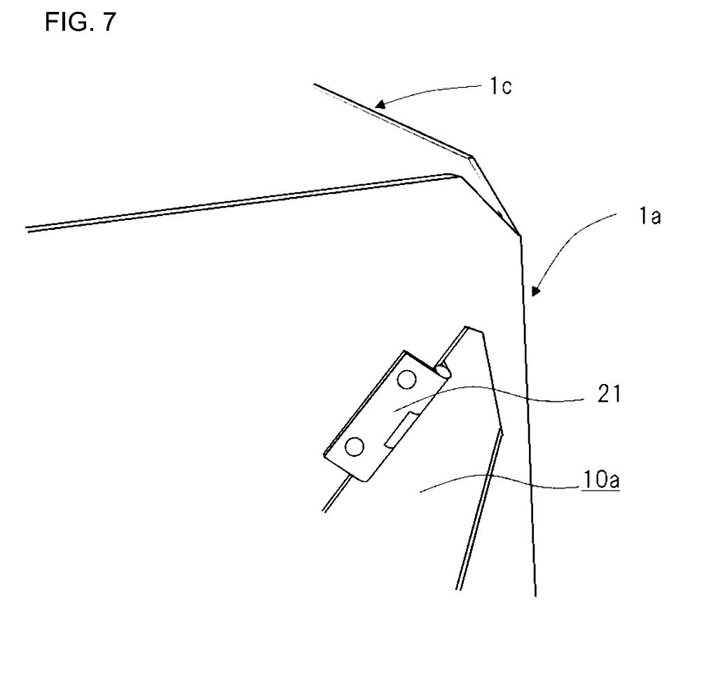

FIG. 7 is a view showing a coffee dripper according to a third embodiment of the present invention. In FIG. 7, parts corresponding to each of the parts shown in the first embodiment are shown with identical reference numerals to the cases in FIG. 1 to FIG. 5, and descriptions are omitted. A difference between the coffee dripper according to the embodiment of FIG. 7 and the coffee dripper 1 according to FIG. 1 to FIG. 5 is that the adjacent plate materials 1a and 1c are connected by a hinge 21. For example, by adopting an approach of connecting the adjacent plate materials 1b and 1c by the hinge 21, and further, temporarily coupling the adjacent plate materials 1a and 1b by the convex engaging parts 14a and 15a and the concave engaging parts 16b and 17b, these three materials 1a, 1b and 1c may be handled collectively also when not in use.

That is to say, the engaging parts may be adopted in any approach, not only in the approach of FIG. 5, but also in the approach of removable engaging by the fitting having a projection 20 and the slit 19 shown in FIG. 6, and/or the approach of fixing by the hinge 21 only having degree of rotational freedom which center is provided by a side as shown in FIG. 7 etc., as long as the engaging parts have a engaging force or a fixing force which may endure use.

As in the above, three embodiments of the present invention are described, but the present invention may further adopt other embodiments.

As described in the above, the present example is of a triangular pyramid shape, but by folding the plate materials 1a, 1b and 1c at one or more lines radially extending from the lowermost point of the paper filter 18 shown in FIG. 4, it is possible to obtain a structure such as a hexagonal pyramid, a dodecagonal pyramid and so on, which fit with the conical paper filter. In this case, when the number of angles is provided as n, a shape having a placing part on a paper filter holding part of an approximate isosceles triangle is made, in which angle θ=180/n is formed by right and left sides of a principal surface. When the number of angles n is increased, the shape approaches a cone shape, and thus usability similar to the conical coffee dripper may be obtained.

In addition, by adopting titanium and/or titanium alloy, etc. as a material of each of the plate materials 1a, 1b and 1c, high-specific rigidity may be obtained. In addition, by using stainless as a material of each of the plate materials 1a, 1b and 1c, same degree of rigidity may be obtained with a material thinner than titanium material. Further, by using a heat resistant resin, it is considered that production with low cost may become available. That is to say, a coffee dripper having various features may be provided depending on the selected material.

1. A coffee dripper comprising:
a first plate material, a second plate material and a third plate material, each of the first, second and third plate material is a generally triangle in shape and comprises a convex engaging part and a concave engaging part, the convex engaging part of the first plate material is configured to engage the concave part of the second plate material, the convex engaging part of the second plate material is configured to engage the concave engaging part of the third material, the convex engaging part of the third plate material is configured to engage the concave engaging part of the first material thereby forming the pyramidally assembled coffee dripper.

2. The coffee dripper according to claim 1, wherein each of the first, second and third plate materials comprises two convex engaging parts and two concave engaging parts, and the two convex engaging parts of one of the plate materials are configured to engage with the two concave engaging parts of the plate material adjacent thereto.

3. The coffee dripper according to claim 1, wherein each of the plate materials comprises a paper filter holding part and a placing part.

4. The coffee dripper according to claim 3, wherein a first opening is formed between the paper holding part and the placing part, the first opening includes the concave engaging part.

5. The coffee dripper according claim 3, wherein a second opening is formed in the paper filter holding part.

6. The coffee dripper according to claim 1, wherein the first, second and third plate materials have a common specification.

7. The coffee dripper according to claim 1, wherein the concave engaging part is a slit.

8. The coffee dripper according to claim 8, wherein the convex engaging part is a projection.

9. The coffee dripper according to claim 1, wherein the convex engaging part is a hinge.
